(19) United States
(12) Patent Application Publication
(10) Pub. No.: US 2026/0278037 A1
(43) Pub. Date: Sep. 17, 2026

(54) METHODS AND APPARATUS FOR MATRIX MULTIPLICATION WITH REINFORCEMENT LEARNING

(71) Applicant: Intel Corporation, Santa Clara, CA (US)

(72) Inventors: Weijie Li, Beijing (CN); Xueshu Wang, Beijing (CN); Lin Xie, Beijing (CN); Zhengxu Huang, Shanghai (CN); Li Xu, Shanghai (CN)

(73) Assignee: Intel Corporation, Santa Clara, CA (US)

(21) Appl. No.: 19/480,201

(22) PCT Filed: May 30, 2023
(86) PCT No.: PCT/CN2023/097097

§ 371 Date: Oct. 30, 2025

(51) Int. Cl. G06F 17/16; G06N 20/00

(52) U.S. Cl. CPC G06F 17/16; G06N 20/00

(57) ABSTRACT

Technical solutions for matrix multiplication with reinforcement learning are disclosed. An example apparatus includes interface circuitry, machine readable instructions, and programmable circuitry to at least one of instantiate or execute the machine readable instructions to identify matrices to be multiplied, split the matrices into subgroups, determine an initial tiling state based on the subgroups, determine an action to perform on the matrices, transform the initial tiling state by executing the action on the matrices, calculate a tiling state latency based on executing the action on the matrices, and update the initial tiling state based on at least one of the transformed tiling state or the calculated tiling state latency.

### FIELD OF THE DISCLOSURE

This disclosure relates generally to scientific computing and, more particularly, to methods and apparatus for matrix multiplication with reinforcement learning.

### BACKGROUND

Matrix multiplication is foundational in scientific computing. Matrix multiplication is defined as multiplying two input matrices together to obtain an output matrix. A linear algebraic routine of multiplying matrices together is utilized in many applications such as image processing, physics simulations, eigenvalue decomposition, etc. More particularly, the General Matrix Multiplication (GEMM), a Basic Linear Algebra Subprograms (BLAS), is a fundamental operator in deep learning (e.g., machine learning, artificial intelligence (AI), neural networks, etc.).

### BRIEF DESCRIPTION OF THE DRAWINGS

FIG. 1A is a block diagram of an example environment in which an example trainer operates to create a tiling solution.

FIG. 1B is an example flow process for creating a soling solution based on a General Matrix Multiplication (GEMM) problem.

FIG. 2 is a block diagram of an example implementation of the tiling solution circuitry of FIG. 1A.

FIG. 3 is an example tiling state to be calculated by the example tiling solution circuitry of FIG. 2.

FIG. 4 is an example machine learning model training process to be used by the tiling state training circuitry of FIG. 2.

FIG. 5 is a flowchart representative of example machine readable instructions and/or example operations that may be executed, instantiated, and/or performed by example programmable circuitry to implement the tiling solution circuitry of FIG. 2.

FIG. 6 is a flowchart representative of example machine readable instructions and/or example operations that may be executed, instantiated, and/or performed by example programmable circuitry to implement the tiling state initialization circuitry of FIG. 2.

FIG. 7 is a flowchart representative of example machine readable instructions and/or example operations that may be executed, instantiated, and/or performed by example programmable circuitry to implement the action determination circuitry of FIG. 2.

FIG. 8 is a block diagram of an example processing platform including programmable circuitry structured to execute, instantiate, and/or perform the example machine readable instructions and/or perform the example operations of FIGS. 5-7 to implement the tiling solution circuitry of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

### DETAILED DESCRIPTION

Matrix multiplication is a computationally intensive operation requiring the use of computational resources. GEMM is foundational to deep learning/AI/neural networks and represents core building blocks to such operations. GEMM operations include computationally heavy, and thus time-consuming, building blocks to create fully connected neural network layers.

Optimization of GEMM operations typically includes manual tiling solution configurations, grid searching throughout the input matrices, random searching throughout the input matrices, and many other methods. Each of these methods introduce complexity and require substantial computational resources to operate, which is inefficient in smaller-scale platforms and/or computationally limited platforms.

Examples disclosed herein provide a deep reinforcement learning model to dynamically perform GEMM operations to produce low latency tiling solutions tailored to the platform in which the GEMM operations are to be executed. In some examples, the calculation size of the GEMM operations are dynamically modified. In some examples, training of a machine learning model is performed based on an iterative execution process.

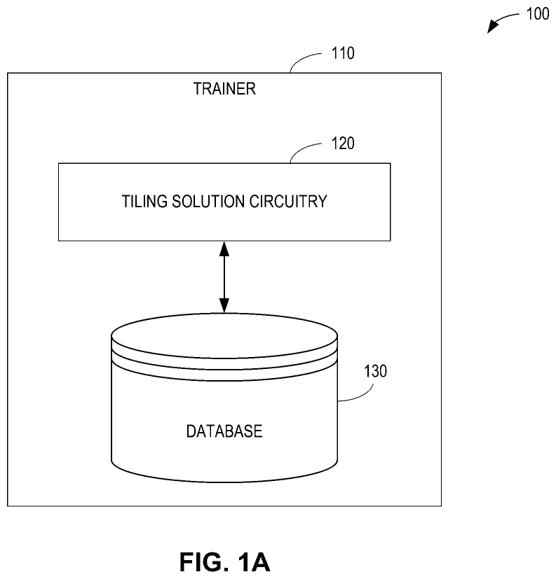

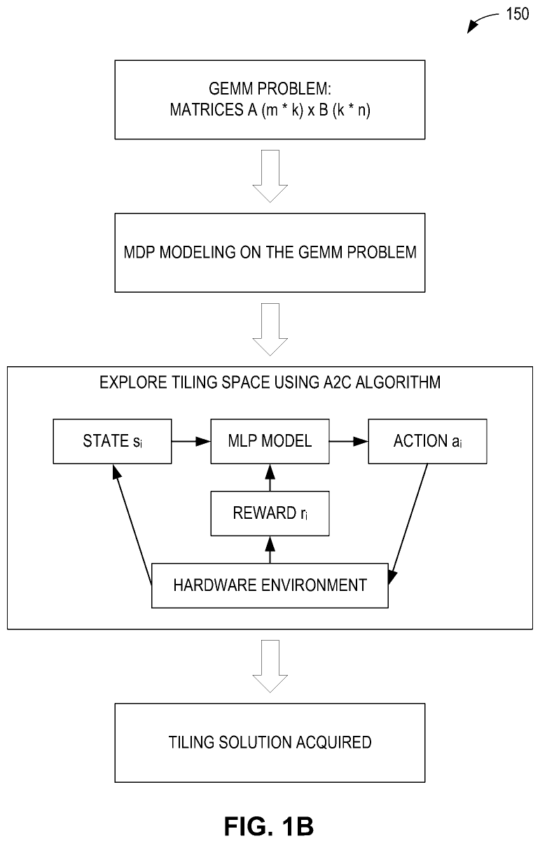

FIG. 1A is a block diagram of an example environment 100 in which an example trainer operates to create a tiling solution (e.g., a matrix multiplication space/calculation permutation for a GEMM problem). The example environment 100 includes a trainer 110 for creating the tiling solution. In some examples, the trainer 110 is trained to learn one or more tiling configurations of the GEMM, such as, for example, modelling the tiling configuration of the GEMM problem as a Markov Decision Process (MDP) with state, policy, and action associated with GEMM tiling configuration. The trained model is reinforced through continuous training (e.g., runtime) such that the model can be adapted to changes of the example environment 100.

The trainer 110 includes tiling solution circuitry 120 and a database 130. In some examples, the tiling solution circuitry 120 communicates with the database 130 within the trainer 110. In some examples, the database 130 is independent of the trainer 110 and communicates with the tiling solution circuitry 120 via a network connection (e.g., WiFi, Ethernet, etc.). The tiling solution circuitry 120 includes instructions to create the tiling solution.

The database 130 stores current and/or previous tiling solutions. In some examples, the database 130 is accessed by the tiling solution circuitry 120 to train a machine learning model based on previous tiling solutions. In some examples, the database 130 stores logs of previous tiling solutions and/or calculation times for the instructions executed by the tiling solution circuitry 120.

FIG. 1B is an example flow process 150 for creating a tiling solution based on a GEMM problem. In the example flow process 150 of FIG. 1B, a GEMM problem includes two matrices (e.g., matrix A with dimension of m×k and matrix B with dimensions of k×n) where an MDP modelling process models the GEMM problem.

The tiling space is explored using an Advantage Actor Critic (A2C) algorithm. The A2C algorithm uses a state design sᵢ, an action design aᵢ, a reward design rᵢ, a multi-layer perceptron (MLP) training strategy (MLP model), and an inference strategy. In some examples, the hardware environment in which the example flow process 150 is executed is changed, and the example flow process 150 is still applicable to the newly changed hardware environment.

Once the tiling space has been explored and the MLP model has been trained, the desired tiling solution with low latency is obtained. The example flow process 150 can be repeated as many times as necessary to re-train the MLP model and obtain a new tiling state with a lower latency.

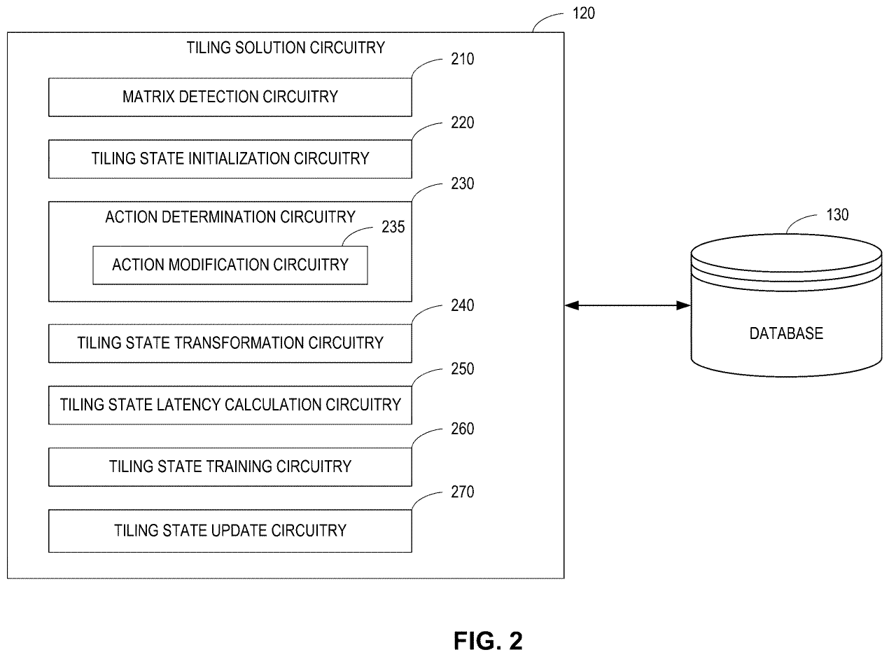

FIG. 2 is a block diagram of an example implementation of the tiling solution circuitry 120 of FIG. 1A to create a tiling solution for a GEMM problem. The tiling solution circuitry 120 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the tiling solution circuitry 120 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The tiling solution circuitry 120 includes matrix detection circuitry 210, tiling state initialization circuitry 220, action determination circuitry 230, action modification circuitry 235, tiling state transformation circuitry 240, tiling state latency calculation circuitry 250, tiling state training circuitry 260, and tiling state update circuitry 270.

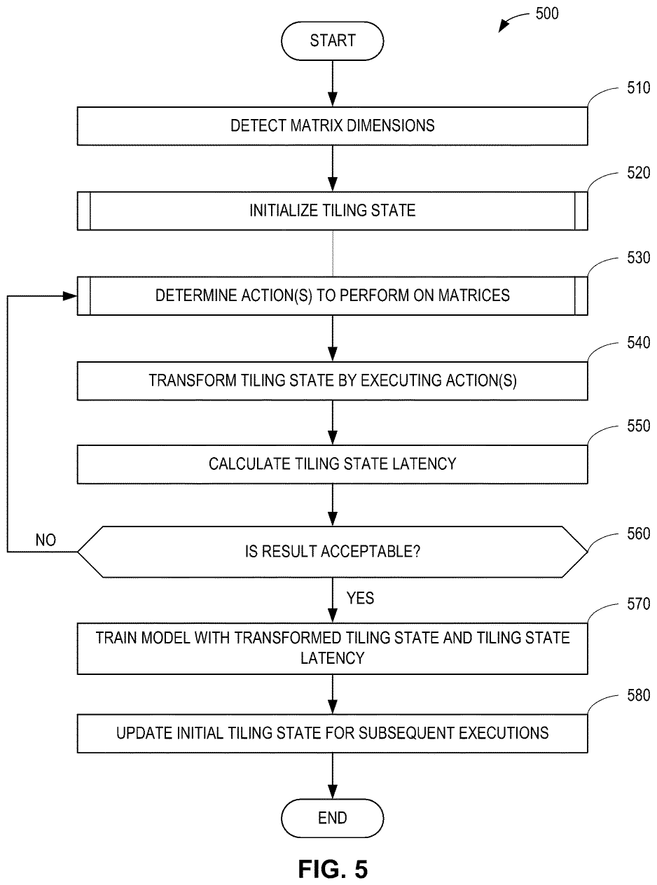

The matrix detection circuitry 210 detects matrices and the dimensions of the matrices. In some examples, the matrix detection circuitry 210 is instantiated by programmable circuitry executing matrix detection instructions and/or configured to perform operations such as those represented by the flowchart of FIG. 5.

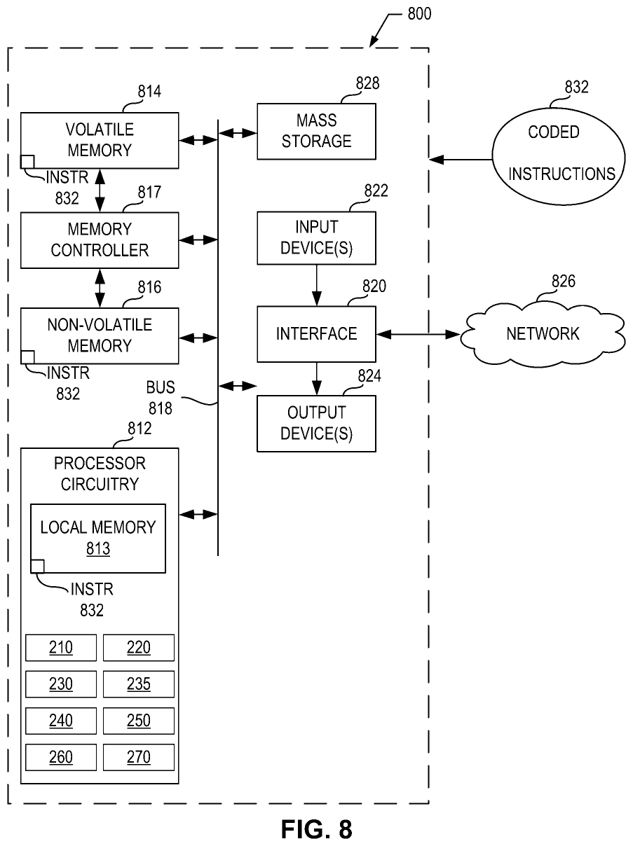

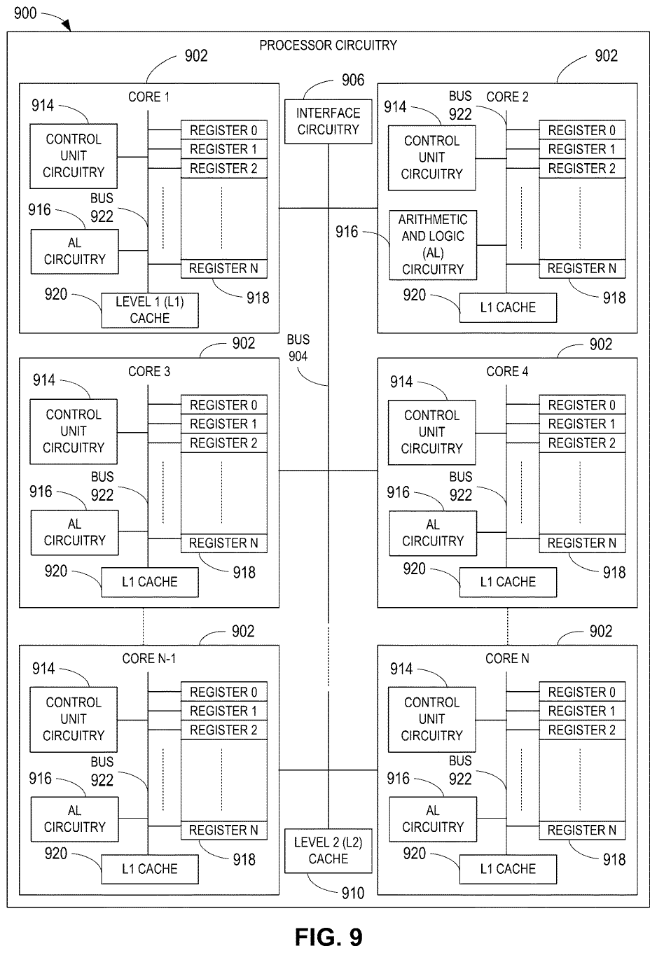

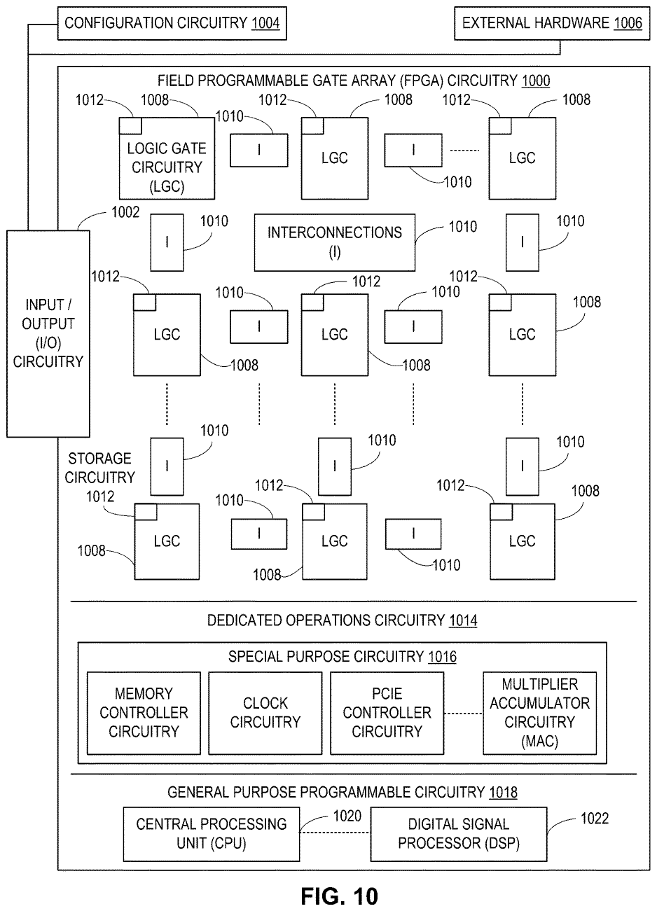

In some examples, the tiling solution circuitry 120 includes means for detecting matrices and matrix dimensions. For example, the means for detecting may be implemented by matrix detection circuitry 210. In some examples, the matrix detection circuitry 210 may be instantiated by programmable circuitry such as the example programmable circuitry 812 of FIG. 8. For instance, the matrix detection circuitry 210 may be instantiated by the example microprocessor 900 of FIG. 9 executing machine executable instructions such as those implemented by at least block 510 of FIG. 5. In some examples, matrix detection circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the matrix detection circuitry 210 may be instantiated by any other combination of hardware, software, and/or firmware. For example, the matrix detection circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The tiling state initialization circuitry 220 initializes a tiling state for the execution of actions on the matrices. In some examples, the tiling state initialization circuitry 220 is instantiated by programmable circuitry executing tiling state initialization instructions and/or configured to perform operations such as those represented by the flowcharts of FIGS. 5 and/or 6.

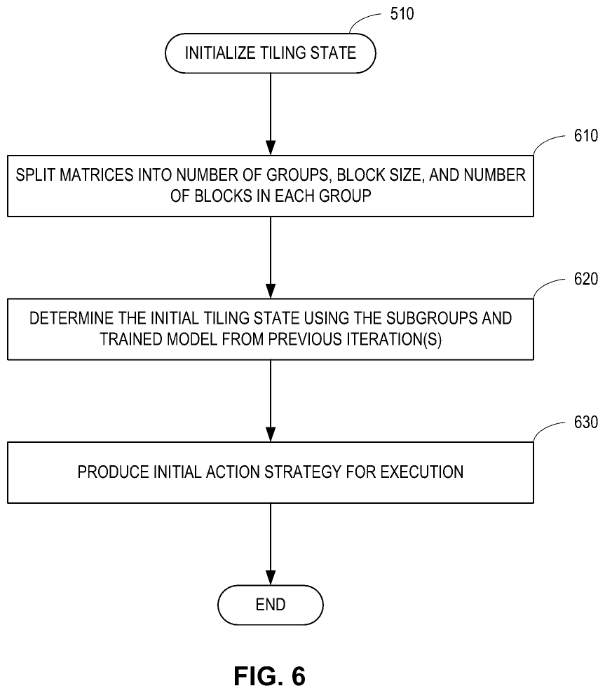

In some examples, the tiling solution circuitry 120 includes means for initializing a tiling state. For example, the means for initializing may be implemented by tiling state initialization circuitry 220. In some examples, the tiling state initialization circuitry 220 may be instantiated by programmable circuitry such as the example programmable circuitry 812 of FIG. 8. For instance, the tiling state initialization circuitry 220 may be instantiated by the example microprocessor 900 of FIG. 9 executing machine executable instructions such as those implemented by at least blocks 520 of FIGS. 5 and 610, 620, and 630 of FIG. 6. In some examples, tiling state initialization circuitry 220 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the tiling state initialization circuitry 220 may be instantiated by any other combination of hardware, software, and/or firmware. For example, the tiling state initialization circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The action determination circuitry 230 determines actions to perform on the matrices. In some examples, the action determination circuitry 230 is instantiated by programmable circuitry executing action determination instructions and/or configured to perform operations such as those represented by the flowcharts of FIGS. 5 and/or 7.

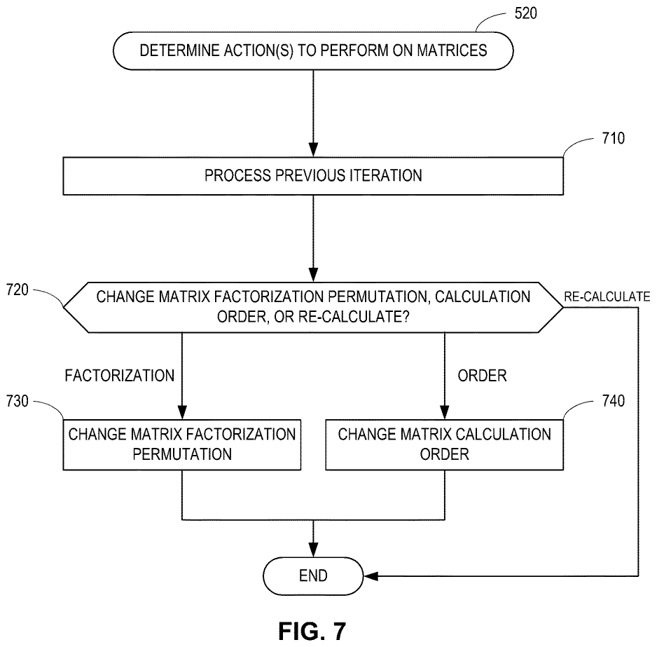

In some examples, the tiling solution circuitry 120 includes means for determining actions to perform on the matrices. For example, the means for determining may be implemented by action determination circuitry 230. In some examples, the action determination circuitry 230 may be instantiated by programmable circuitry such as the example programmable circuitry 812 of FIG. 8. For instance, the action determination circuitry 230 may be instantiated by the example microprocessor 900 of FIG. 9 executing machine executable instructions such as those implemented by at least blocks 530 of FIGS. 5 and 710 and 720 of FIG. 7. In some examples, action determination circuitry 230 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the action determination circuitry 230 may be instantiated by any other combination of hardware, software, and/or firmware. For example, the action determination circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The action modification circuitry 235 modifies the actions to be performed on the matrices. In some examples, the action modification circuitry 235 is instantiated by programmable circuitry executing action modification instructions and/or configured to perform operations such as those represented by the flowchart of FIG. 7.

In some examples, the tiling solution circuitry 120 includes means for updating a factorization permutation or a calculation order of the actions performed on the matrices. For example, the means for updating may be implemented by action modification circuitry 235. In some examples, the action modification circuitry 235 may be instantiated by programmable circuitry such as the example programmable circuitry 812 of FIG. 8. For instance, the action modification circuitry 235 may be instantiated by the example microprocessor 900 of FIG. 9 executing machine executable instructions such as those implemented by at least blocks 730 and 740 FIG. 7. In some examples, action modification circuitry 235 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the action modification circuitry 235 may be instantiated by any other combination of hardware, software, and/or firmware. For example, the action modification circuitry 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The tiling state transformation circuitry 240 transforms the initial tiling state by executing the actions on the matrices. In some examples, the tiling state transformation circuitry 240 is instantiated by programmable circuitry executing tiling state transformation instructions and/or configured to perform operations such as those represented by the flowchart of FIG. 5.

In some examples, the tiling solution circuitry 120 includes means for transforming the initial tiling state by executing the actions on the matrices. For example, the means for transforming may be implemented by tiling state transformation circuitry 240. In some examples, the tiling state transformation circuitry 240 may be instantiated by programmable circuitry such as the example programmable circuitry 812 of FIG. 8. For instance, the tiling state transformation circuitry 240 may be instantiated by the example microprocessor 900 of FIG. 9 executing machine executable instructions such as those implemented by at least block 540 and 560 of FIG. 5. In some examples, tiling state transformation circuitry 240 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the tiling state transformation circuitry 240 may be instantiated by any other combination of hardware, software, and/or firmware. For example, the tiling state transformation circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The tiling state latency calculation circuitry 250 calculates a tiling state latency for the actions performed on the matrices. In some examples, the tiling state latency calculation circuitry 250 is instantiated by programmable circuitry executing tiling state latency calculation instructions and/or configured to perform operations such as those represented by the flowchart of FIG. 5.

In some examples, the tiling solution circuitry 120 includes means for calculating a tiling state latency based on executing the actions on the matrices. For example, the means for calculating may be implemented by tiling state latency calculation circuitry 250. In some examples, the tiling state latency calculation circuitry 250 may be instantiated by programmable circuitry such as the example programmable circuitry 812 of FIG. 8. For instance, the tiling state latency calculation circuitry 250 may be instantiated by the example microprocessor 900 of FIG. 9 executing machine executable instructions such as those implemented by at least block 550 of FIG. 5. In some examples, tiling state latency calculation circuitry 250 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the tiling state latency calculation circuitry 250 may be instantiated by any other combination of hardware, software, and/or firmware. For example, the tiling state latency calculation circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The tiling state training circuitry 260 trains a machine learning model using the transformed tiling state and the calculated tiling state latency. In some examples, the tiling state training circuitry 260 is instantiated by programmable circuitry executing tiling state training instructions and/or configured to perform operations such as those represented by the flowchart of FIG. 5.

In some examples, the tiling solution circuitry 120 includes means for training a machine learning model using the transformed tiling state and the calculated tiling state latency. For example, the means for training may be implemented by tiling state training circuitry 260. In some examples, the tiling state training circuitry 260 may be instantiated by programmable circuitry such as the example programmable circuitry 812 of FIG. 8. For instance, the tiling state training circuitry 260 may be instantiated by the example microprocessor 900 of FIG. 9 executing machine executable instructions such as those implemented by at least block 570 of FIG. 5. In some examples, tiling state training circuitry 260 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the tiling state training circuitry 260 may be instantiated by any other combination of hardware, software, and/or firmware. For example, the tiling state training circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The tiling state update circuitry 270 updates the initial tiling state based on the transformed tiling state, the calculated tiling state latency, and/or a retrained machine learning model (e.g., on subsequent iterations of the training). In some examples, the tiling state update circuitry 270 is instantiated by programmable circuitry executing tiling state update instructions and/or configured to perform operations such as those represented by the flowchart of FIG. 5.

In some examples, the tiling solution circuitry 120 includes means for updating the initial tiling state based on the transformed tiling state, and calculated tiling state latency, and/or the retrained machine learning model. For example, the means for updating may be implemented by tiling state update circuitry 270. In some examples, the tiling state update circuitry 270 may be instantiated by programmable circuitry such as the example programmable circuitry 812 of FIG. 8. For instance, the tiling state update circuitry 270 may be instantiated by the example microprocessor 900 of FIG. 9 executing machine executable instructions such as those implemented by at least block 580 of FIG. 5. In some examples, tiling state update circuitry 270 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the tiling state update circuitry 270 may be instantiated by any other combination of hardware, software, and/or firmware. For example, the tiling state update circuitry 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the tiling solution circuitry 120 of FIG. 1A is illustrated in FIG. 2, one or more of the elements, processes, and/or devices illustrated in FIG. 2 may be combined, divided, re-arranged, omitted, eliminated, and/or implemented in any other way. Further, the example matrix detection circuitry 210, example tiling state initialization circuitry 220, example action determination circuitry 230, example action modification circuitry 235, example tiling state transformation circuitry 240, example tiling state latency calculation circuitry 250, example tiling state training circuitry 260, example tiling state update circuitry 270, and/or, more generally, the example tiling solution circuitry 120 of FIG. 2, may be implemented by hardware alone or by hardware in combination with software and/or firmware. Thus, for example, any of the example matrix detection circuitry 210, example tiling state initialization circuitry 220, example action determination circuitry 230, example action modification circuitry 235, example tiling state transformation circuitry 240, example tiling state latency calculation circuitry 250, example tiling state training circuitry 260, example tiling state update circuitry 270, and/or, more generally, the example tiling solution circuitry 120, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example tiling solution circuitry 120 of FIG. 2 may include one or more elements, processes, and/or devices in addition to, or instead of, those illustrated in FIG. 2, and/or may include more than one of any or all of the illustrated elements, processes and devices.

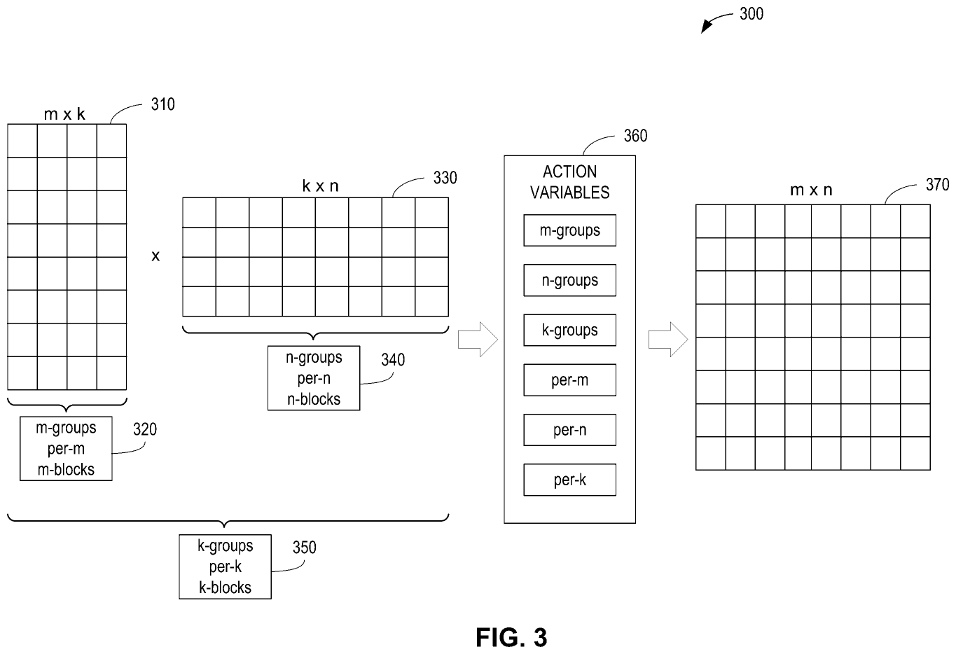

FIG. 3 is an example tiling state 300 to be calculated by the example tiling solution circuitry 120 of FIG. 2. The example tiling state 300 includes a first matrix 310 including a first subgroup 320, a second matrix 330 including a second subgroup 340, a third subgroup 350, an arrangement of action variables 360, and a third matrix 370.

The first matrix 310 includes m rows and k columns (e.g., dimensions of m×k). In examples disclosed herein, the first matrix 310 is split into the first subgroup 320. In some examples, the first subgroup 320 includes subdivisions such as m-groups representing the number of groups per rows (m_{group}), m-blocks representing the number of blocks per row (m_{block}), and per-m representing the number of blocks per group (m_{block-per-grou}). In some examples, each of the subdivisions of the first subgroup 320 are determined independently.

The second matrix 330 includes k rows and n columns (e.g., dimensions of k×n). In examples disclosed herein, the second matrix 330 is split into the second subgroup 340. In some examples, the second subgroup 340 includes the same subdivisions as the first subgroup 320 tailored to the n dimension such as n-groups representing the number of groups per column (n_{group}), n-blocks representing the number of blocks per column (n_{block}), and per-n representing the number of blocks per group (n_{block-per-gr}). In some examples, each of the subdivisions of the second subgroup 340 are determined independently.

The third subgroup 350 includes subdivisions for the k dimension of the first and second matrices 310, 330. In some examples, the third subgroup 350 includes the same subdivisions as the first and second subgroups 320, 340 tailored to the k dimension such as k-groups representing the number of groups in the k dimension (k_{group}), k-blocks representing the number of blocks in the k dimension (k_{block}), and per-k representing the number of blocks per group in the k dimension (k_{block-per-gro}). In some examples, each of the subdivisions of the third subgroup 350 are determined independently.

The arrangement of action variables 360 includes each of the first, second, and third subgroups 320, 340, 350 arranged to perform a multiplication operation on the matrices 310, 330. In some examples, each of the subdivisions of the first, second, and third subgroups 320, 340, 350 are arranged in an initial factorization permutation (e.g., specific numbers in each subdivision) and calculation order (e.g., multiplication iteration). The determination of which actions to perform and what order to perform the actions is described in further detail herein (e.g., FIG. 7).

The third matrix 370 is the resulting matrix from performing the actions/calculations on the first matrix 310 and the second matrix 330 (e.g., performing a matrix multiplication operation). The third matrix includes m rows and n columns (e.g., dimensions of m×n).

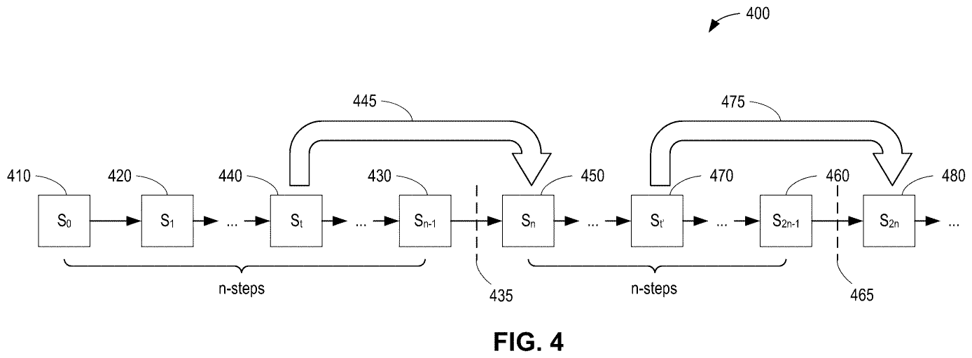

FIG. 4 is an example machine learning model training process 400 to be used by the tiling state training circuitry 260 of FIG. 2. The example machine learning model training process 400 trains the machine learning model at every n-steps and updates the next iteration with the lowest latency tiling state from the training of the model.

In some examples, the machine learning model training process 400 initializes using a first starting tiling state 410. After a single calculation (e.g., the actions performed on the matrices 310, 330 result in a calculated tiling state latency), the process 400 re-calculates the tiling state to obtain a second tiling state 420. The actions are then re-performed on the matrices 310, 330 for n-steps to obtain a final tiling state for the first iteration 430. Once the final tiling state for the first iteration 430 is obtained, a first training 435 is performed. During such time, a first lowest latency tiling state 440 is obtained (e.g., by comparing each iteration against each other to determine the lowest latency tiling state). The first lowest latency tiling state 440 is applied (e.g., illustrated by arrow 445) to a second tiling starting state 450.

The process 400 repeats for the second training cycle where a final tiling state for the second iteration 460 is obtained and a second training 465 is performed. A second lowest latency tiling state 470 is obtained through the second training cycle and is subsequently applied (e.g., illustrated by arrow 475) to a third tiling starting state 480. The process 400 continues for as many training cycles is necessary to reduce the tiling state latency to acceptable levels (e.g., based on program/execution requirements, etc.).

Flowchart(s) representative of example machine readable instructions, which may be executed by programmable circuitry to implement and/or instantiate the tiling solution circuitry 120 of FIG. 2 and/or representative of example operations which may be performed by programmable circuitry to implement and/or instantiate the tiling solution circuitry 120 of FIG. 2, are shown in FIGS. 5-7. The machine readable instructions may be one or more executable programs or portion(s) of one or more executable programs for execution by programmable circuitry such as the processor circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-7, many other methods of implementing the example tiling solution circuitry 120 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 300 that may be executed, instantiated, and/or performed by programmable circuitry to perform actions on matrices. The example machine-readable instructions and/or the example operations 500 of FIG. 5 begin at block 510, at which the matrix detection circuitry 210 detects/identifies matrix dimensions. In some examples, the matrix detection circuitry 210 detects the dimensions of two matrices in which to multiply together. Such an example includes a first matrix 310 with dimensions of m rows and k columns and a second matrix 330 with dimensions of k rows and n columns.

When the matrix detection circuitry 210 detects the dimensions of the first matrix 310 and the second matrix 330, the tiling state initialization circuitry 220 initializes the tiling state for actions to be executed on the first and second matrix 310, 330. (Block 520). In some examples, the initial tiling state is an empty tiling state. In other examples, the initial tiling state is non-empty and is updated based upon a previous action execution on the matrices 310, 330. In some examples, the tiling state is represented by Equation 1:

$${s}_{i} = [ {F}_{m} , {F}_{k} , {F}_{n} , {O}_{mkn} , J ] \qquad Equation 1$$

As represented by Equation 1, sᵢ is the tiling state, Fₘ represents the tiling space in the m dimension, Fₖ represents the tiling space in the k dimension, Fₙ represents the tiling space in the n dimension, Oₘₖₙ represents the calculation order of the matrices 310, 330 (e.g., the calculation order of Oₘₖₙ would be in the m dimension first, k dimension second, and n dimension third), and J represents the validity of the current tiling state.

As disclosed above, the matrices 310, 330 can be split to enable computations to execute quicker on the matrices 310, 330. As such, the tiling space in the m dimension (Fₘ), the tiling space in the k dimension (Fₖ), and the tiling space in the n dimension (Fₙ) can be represented by Equations 2-4 below:

$${F}_{m} = [ {m}_{group} , {m}_{block - per - gro} , {m}_{block} ] \qquad Equation 2$$

$${F}_{k} = [ {k}_{group} , {k}_{block - per - gr} , {k}_{block} ] \qquad Equation 3$$

$${F}_{n} = [ {n}_{group} , {n}_{block - per - gr} , {n}_{block} ] \qquad Equation 4$$

As shown in Equations 2-4, m_{group}, k_{group}, and n_{group} represent the number of groups in the m, k, and n dimension the matrices 310, 330 are split into respectively, m_{block}, k_{block}, and n_{block} represent the block size in the m, k, and n dimensions the matrices 310, 330 are split into respectively, and m_{block-per-gr}, k_{block-per-group}, and n_{block-per-grou} represent the number of blocks per group in the m, k, and n dimensions of the matrices 310, 330 respectively. If all factorizations are within a valid range and satisfy multiplying constraints (e.g, m_{group}×m_{block-per-gr}×m_{block}=m, where m is a dimension of the first matrix 310), then such a state is classified as valid (e.g., J returns a valid state).

Once the tiling state has been initialized by the tiling state initialization circuitry 220, the action determination circuitry 230 determines actions to perform on the matrices 310, 330. (Block 530). In some examples, the actions to perform on the matrices 310, 330 include any one of a re-calculation, a change to the matrix factorization permutation, or a change to the matrix calculation order. The determination of which action to perform is disclosed in further detail herein in reference to FIG. 7.

Once the actions to perform on the matrices 310, 330 have been determined by the action determination circuitry 230, the tiling state transformation circuitry 240 transforms the tiling state by executing the actions on the matrices 310, 330. (Block 540). In the examples disclosed herein, the tiling state is transformed into the third matrix 370 (e.g., the resulting matrix after the multiplication of the first matrix 310 and the second matrix 330).

Once the actions are performed on the matrices 310, 330 by the tiling state transformation circuitry 240, the tiling state latency calculation circuitry 250 calculates a tiling state latency for the actions performed. (Block 550). In examples disclosed herein, the tiling state latency is the amount of time taken to perform the actions on the matrices 310, 330. In some examples, the tiling state latency is calculated using Equation 5 or Equation 6:

$$r ( s , a ) = \frac{1}{cos t ( {s}^{′} ; m , k , n )} \qquad Equation 5$$

$$r ( s , a ) = \frac{cos t ( {s}_{0} ; m , k , n )}{cos t ( {s}^{′} ; m , k , n )} \qquad Equatio n 6$$

In Equation 5 and 6 above, r (s, a) is the tiling state latency based upon the transformed tiling state s′, where s is the tiling state solution and a is the actions performed on the matrices 310, 330. In Equation 5, the tiling state latency is calculated using the transformed tiling state s′. Such an example uses an absolute latency calculation where the matrices 310, 330 are relatively low in size. Conversely, in Equation 6, the tiling state latency uses a relative latency calculation taking the latency of the initial tiling state s₀ where the matrices 310, 330 are larger in size and require more calculation time to execute the actions a.

Once the tiling state latency is calculated by the tiling state latency calculation circuitry 250, the tiling state transformation circuitry 240 determines whether the result is acceptable to output (e.g., meets latency requirements). (Block 560). In some examples, the latency requirements for a given calculation is determined by the size of the matrices 310, 330 (e.g., proportional to the relative dimensions of the input matrices). When the tiling state transformation circuitry 240 determines that the result is not acceptable (e.g., block 560 returns a result of NO), blocks 530-560 are repeated until the result is acceptable.

When the tiling state transformation circuitry 240 determines that the result is acceptable (e.g., block 560 returns a result of YES), the tiling state training circuitry 260 trains a machine learning model using the transformed tiling state and the calculated tiling state latency. (Block 570). In some examples, the tiling state training circuitry 260 utilizes an Advantage Actor Critic (A2C) algorithm to train the machine learning model. In some examples, the machine learning model is a multilayer perceptron (MLP) neural network. The A2C algorithm and the MLP neural network serve as example implementations of training a machine learning model. As such, any alternative method of training can be interchangeably used herein.

Once the machine learning model is trained or retrained by the tiling state training circuitry 260, the tiling state update circuitry 270 updates the initial tiling state based on the transformed tiling state, calculated tiling state latency, and retrained machine learning model. (Block 580). In some examples, updating the initial tiling state with a transformed tiling state creates a new starting point for the actions to be performed on the matrices 310, 330. Such a new starting point can reduce latency in subsequent calculations and assist in better training of the machine learning model to create better starting points on subsequent calculations.

When the initial tiling state has been updated using the transformed tiling state by the tiling state update circuitry 270, the example machine-readable instructions and/or the example operations 500 of FIG. 5 ends.

FIG. 6 is a flowchart representative of example machine readable instructions and/or example operations that may be executed, instantiated, and/or performed by programmable circuitry to initialize a tiling state. The example machine-readable instructions and/or the example operations of FIG. 6 begin at block 610, at which the tiling state initialization circuitry 220 splits the matrices 310, 330 into pre-defined subgroups. In some examples, the pre-defined subgroups include splitting the matrices 310, 330 into a number of groups (e.g., m_{group}), a block size (e.g., m_{block}), and a number of blocks in each group (e.g., m_{block-per-gr}).

Once the tiling state initialization circuitry 220 splits the matrices 310, 330 into the subgroups, the tiling state initialization circuitry 220 determines the initial tiling state using the subgroups. (Block 620). In some examples, where a previous calculation has already occurred, the tiling state initialization circuitry 220 also uses the trained or retrained machine learning model from the previous calculation to assist in determining the initial tiling state. The initial tiling state is represented by Equations 1-4 above.

Once the tiling state initialization circuitry 220 determines the initial tiling state, the tiling state initialization circuitry 220 produces an initial action strategy for executing the actions on the matrices 310, 330. (Block 630). In some examples, the initial action strategy is produced using a separate machine learning model to analyze the matrices 310, 330 and/or the initial tiling state to determine the calculation order (e.g., Oₘₖₙ) or an initial factorization permutation. In some examples, this assists the action determination circuitry 230 in quickly determining the actions to perform on the matrices 310, 330.

Once the initial action strategy is determined by the tiling state initialization circuitry 230, the example machine-readable instructions and/or the example operations of FIG. 6 ends.

FIG. 7 is a flowchart representative of example machine readable instructions and/or example operations that may be executed, instantiated, and/or performed by programmable circuitry to determine the actions to perform on the matrices 310, 330. The example machine-readable instructions and/or the example operations of FIG. 7 begin at block 710, at which the action determination circuitry 230 processes the previous calculation iteration. In some examples, the processing includes determining what the calculated tiling state latency is for the previous iteration. In some examples, the processing includes determining the current tiling state. Such a determination of the actions to perform on the matrices 310, 330 include an analysis of the computational resources available to the platform in which the example machine readable instructions and/or example operations are to be executed on such as the type of processor, the amount of memory available (e.g., RAM), current and/or future workloads of the platform, etc.

Once the action determination circuitry 230 processes the previous calculation iteration, the action determination circuitry 230 determines whether the actions to be performed on the matrices 310, 330 should be changed. (Block 720). In some examples, the action determination circuitry 230 determines that no changes need to be made. In such an example, the action determination circuitry 230 outputs that the actions are to be re-performed (e.g., recalculation) and the example machine-readable instructions and/or the example operations 700 of FIG. 7 (e.g., block 720 returns a result of RE-CALCULATE).

When the action determination circuitry 230 determines that changes to the matrix factorization permutation are desired (e.g., block 720 returns a result of FACTORIZATION), the action modification circuitry 235 changes the matrix factorization permutation. (Block 730). In some examples, changes to the factorization permutation include keeping one factor constant (e.g., keeping the number of groups (e.g., m_{group})) while changing the other two factors (e.g., changing the block size (e.g., m_{block}), and the number of blocks in each group (e.g., m_{block-per-gr})). Alternatively, the block size or the number of blocks per group could be kept constant while the remaining two factors are modified.

When the action determination circuitry 230 determines that changes to the calculation order are desired, (e.g., block 720 returns a result of ORDER), the action modification circuitry 235 changes the calculation order. (Block 740). In some examples, the order in which dimension is calculated first affects the latency of the calculation. One such example may be to calculate the smallest dimension first. Another such example may be to calculate the largest dimension first. Alternatively, in some examples, the calculation order may be modified based on any other determining factor such as relative complexity of the matrices 310, 330, computational resources available, etc.

When the action determination circuitry 230 determines that no changes are to be made, when the action modification circuitry 235 determines that changes to the matrix factor permutation are to be made, or when the action modification circuitry 235 changes the matrix calculation order, the example machine-readable instructions and/or the example operations of FIG. 7 ends.

FIG. 8 is a block diagram of an example programmable circuitry platform 800 structured to execute and/or instantiate the example machine-readable instructions and/or the example operations of FIGS. 5-7 to implement the tiling solution circuitry 120 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements matrix detection circuitry 210, tiling state initialization circuitry 220, action determination circuitry 230, action modification circuitry 235, tiling state transformation circuitry 240, tiling state latency calculation circuitry 250, tiling state training circuitry 260, and tiling state update circuitry 270.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 5-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 5-7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 5-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-7. As such, the FPGA circuitry 1000 may be configured and/or structured to effectively instantiate some or all of the operations/functions corresponding to the machine readable instructions of the flowchart(s) of FIGS. 5-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 5-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 5-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 5-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 5-7, and/or an ASIC may be configured and/or structured to perform third operation(s)/function(s) corresponding to a third portion of the machine readable instructions represented by the flowcharts of FIGS. 5-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

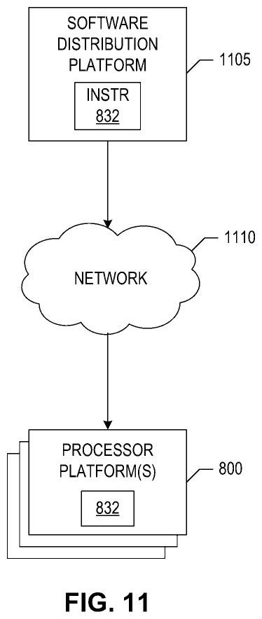

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 5-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 5-7, may be downloaded to the example programmable circuitry platform 800, which is to execute the machine readable instructions 832 to implement the tiling solution circuitry 120. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that implement matrix multiplication with reinforcement learning. Disclosed systems, apparatus, articles of manufacture, and methods improve the efficiency of using a computing device by modifying a tiling solution based on a machine learning model to provide low latency matrix multiplication operations which is dynamically applicable to platforms based on computational resources available. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to implement matrix multiplication with reinforcement learning are disclosed herein. Further examples and combinations thereof include the following:
Example 1 includes an apparatus comprising interface circuitry, machine readable instructions, and programmable circuitry to at least one of instantiate or execute the machine readable instructions to identify matrices to be multiplied, split the matrices into subgroups, determine an initial tiling state based on the subgroups, determine an action to perform on the matrices, transform the initial tiling state by executing the action on the matrices, calculate a tiling state latency based on executing the action on the matrices, and update the initial tiling state based on at least one of the transformed tiling state or the calculated tiling state latency.

Example 2 includes the apparatus of example 1, wherein the programmable circuitry is to produce an initial action strategy using the initial tiling state, the initial action strategy including at least one of a factorization permutation of one of the subgroups and a calculation order in which the matrices are multiplied.

Example 3 includes the apparatus of example 1, wherein the programmable circuitry is to train a machine learning model using at least the initial tiling state of one or more subgroups of the identified matrices.

Example 4 includes the apparatus of example 3, wherein the programmable circuitry is to retrain the machine learning model using the transformed tiling state and the calculated tiling state latency.

Example 5 includes the apparatus of example 4, wherein the programmable circuitry is to update the initial tiling state based on the retrained machine learning model.

Example 6 includes the apparatus of example 1, wherein the programmable circuitry is to update a factorization permutation of one of the subgroups based on a trained machine learning model.

Example 7 includes the apparatus of example 1, wherein the programmable circuitry is to update a calculation order in which the matrices are multiplied based on a trained machine learning model.

Example 8 includes the apparatus of example 1, wherein the subgroups include at least one of a number of groups, a block size, and a number of blocks in each group.

Example 9 includes a non-transitory machine readable storage medium comprising instructions to cause programmable circuitry to at least identify matrices to be multiplied, split the matrices into subgroups, determine an initial tiling state based on the subgroups, determine an action to perform on the matrices, transform the initial tiling state by executing the action on the matrices, calculate a tiling state latency based on executing the action on the matrices, and update the initial tiling state based on at least one of the transformed tiling state or the calculated tiling state latency.

Example 10 includes the non-transitory machine readable storage medium of example 9, wherein the instructions cause the programmable circuitry to produce an initial action strategy using the initial tiling state, the initial action strategy including at least one of a factorization permutation of one of the subgroups and a calculation order in which the matrices are multiplied.

Example 11 includes the non-transitory machine readable storage medium of example 9, wherein the instructions cause the programmable circuitry to train a machine learning model using at least the initial tiling state of one or more subgroups of the identified matrices.

Example 12 includes the non-transitory machine readable storage medium of example 11, wherein the instructions cause the programmable circuitry to retrain the machine learning model using the transformed tiling state and the calculated tiling state.

Example 13 includes the non-transitory machine readable storage medium of example 12, wherein the instructions cause the programmable circuitry to update the initial tiling state based on the retrained machine learning model.

Example 14 includes the non-transitory machine readable storage medium of example 9, wherein the instructions cause the programmable circuitry to update a factorization permutation of one of the subgroups based on a trained machine learning model.

Example 15 includes the non-transitory machine readable storage medium of example 9, wherein the instructions cause the programmable circuitry to update a calculation order in which the matrices are multiplied based on a trained machine learning model.

Example 16 includes the non-transitory machine readable storage medium of example 9, wherein the subgroups include at least one of a number of groups, a block size, and a number of blocks in each group.

Example 17 includes an apparatus comprising means for detecting matrices to be multiplied, means for initializing a tiling state, the means for initializing to split the matrices into subgroups, and determine an initial tiling state based on the subgroups, means for determining an action to perform on the matrices, means for transforming the initial tiling state by executing the action on the matrices, means for calculating a tiling state latency based on executing the action on the matrices, and means for updating the initial tiling state based on at least one of the transformed tiling state or calculated tiling state latency.

Example 18 includes the apparatus of example 17, wherein the means for initializing is further to produce an initial action strategy using the initial tiling state, the initial action strategy including at least one of a factorization permutation of one of the subgroups and a calculation order in which the matrices are multiplied.

Example 19 includes the apparatus of example 17, further including means for training a machine learning model using at least the initial tiling state of one or more subgroups of the detected matrices.

Example 20 includes the apparatus of example 19, wherein the means for training is to retrain the machine learning model using the transformed tiling state and the calculated tiling state latency.

Example 21 includes the apparatus of example 20, wherein the means for initializing is to update the initial tiling state based on the retrained machine learning model.

Example 22 includes the apparatus of example 17, further including means for updating a factorization permutation of one of the subgroups based on a trained machine learning model.

Example 23 includes the apparatus of example 17, further including means for updating a calculation order in which the matrices are multiplied based on a trained machine learning model.

Example 24 includes the apparatus of example 17, wherein the subgroups include at least one of a number of groups, a block size, and a number of blocks in each group.

Example 25 includes a method comprising identifying matrices to be multiplied, splitting the matrices into subgroups, and determining an initial tiling state based on the subgroups, determining an action to perform on the matrices, transforming the initial tiling state by executing the action on the matrices, calculating a tiling state latency based on executing the action on the matrices, and updating the initial tiling state based on at least one of the transformed tiling state or the calculated tiling state latency.

Example 26 includes the method of example 25, further including producing an initial action strategy using the initial tiling state, the initial action strategy including at least one of a factorization permutation of one of the subgroups and a calculation order in which the matrices are multiplied.

Example 27 includes the method of example 25, further including training a machine learning model using at least the initial tiling state of one or more subgroups of the identified matrices.

Example 28 includes the method of example 27, further including retraining the machine learning model using the transformed tiling state and the calculated tiling state latency.

Example 29 includes the method of example 28, further including updating the initial tiling state based on the retrained machine learning model.

Example 30 includes the method of example 25, further including updating a factorization permutation of one of the subgroups based on a trained machine learning model.

Example 31 includes the method of example 25, further including updating update a calculation order in which the matrices are multiplied based on a trained machine learning model.

Example 32 includes the method of example 25, wherein the subgroups include at least one of a number of groups, a block size, and a number of blocks in each group.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine readable instructions; and
programmable circuitry to at least one of instantiate or execute the machine readable instructions to:
identify matrices to be multiplied;
split the matrices into subgroups;
determine an initial tiling state based on the subgroups;
determine an action to perform on the matrices;
transform the initial tiling state by executing the action on the matrices;
calculate a tiling state latency based on executing the action on the matrices; and
update the initial tiling state based on at least one of the transformed tiling state or the calculated tiling state latency.

2. The apparatus of claim 1, wherein the programmable circuitry is to produce an initial action strategy using the initial tiling state, the initial action strategy including at least one of a factorization permutation of one of the subgroups and a calculation order in which the matrices are multiplied.

3. The apparatus of claim 1, wherein the programmable circuitry is to train a machine learning model using at least the initial tiling state of one or more subgroups of the identified matrices.

4. The apparatus of claim 3, wherein the programmable circuitry is to retrain the machine learning model using the transformed tiling state and the calculated tiling state latency.

5. The apparatus of claim 4, wherein the programmable circuitry is to update the initial tiling state based on the retrained machine learning model.

6. The apparatus of claim 1, wherein the programmable circuitry is to update a factorization permutation of one of the subgroups based on a trained machine learning model.

7. The apparatus of claim 1, wherein the programmable circuitry is to update a calculation order in which the matrices are multiplied based on a trained machine learning model.

8. The apparatus of claim 1, wherein the subgroups include at least one of a number of groups, a block size, and a number of blocks in each group.

9. A non-transitory machine readable storage medium comprising instructions to cause programmable circuitry to at least:
identify matrices to be multiplied;
split the matrices into subgroups;
determine an initial tiling state based on the subgroups;
determine an action to perform on the matrices;
transform the initial tiling state by executing the action on the matrices;
calculate a tiling state latency based on executing the action on the matrices; and
update the initial tiling state based on at least one of the transformed tiling state or the calculated tiling state latency.

10. The non-transitory machine readable storage medium of claim 9, wherein the instructions cause the programmable circuitry to produce an initial action strategy using the initial tiling state, the initial action strategy including at least one of a factorization permutation of one of the subgroups and a calculation order in which the matrices are multiplied.

11. The non-transitory machine readable storage medium of claim 9, wherein the instructions cause the programmable circuitry to train a machine learning model using at least the initial tiling state of one or more subgroups of the identified matrices.

12. The non-transitory machine readable storage medium of claim 11, wherein the instructions cause the programmable circuitry to retrain the machine learning model using the transformed tiling state and the calculated tiling state.

13. The non-transitory machine readable storage medium of claim 12, wherein the instructions cause the programmable circuitry to update the initial tiling state based on the retrained machine learning model.

14. The non-transitory machine readable storage medium of claim 9, wherein the instructions cause the programmable circuitry to update a factorization permutation of one of the subgroups based on a trained machine learning model.

15. The non-transitory machine readable storage medium of claim 9, wherein the instructions cause the programmable circuitry to update a calculation order in which the matrices are multiplied based on a trained machine learning model.

16. The non-transitory machine readable storage medium of claim 9, wherein the subgroups include at least one of a number of groups, a block size, and a number of blocks in each group.

17. An apparatus comprising:
means for detecting matrices to be multiplied;
means for initializing a tiling state, the means for initializing to:
split the matrices into subgroups; and
determine an initial tiling state based on the subgroups;
means for determining an action to perform on the matrices;
means for transforming the initial tiling state by executing the action on the matrices;
means for calculating a tiling state latency based on executing the action on the matrices; and
means for updating the initial tiling state based on at least one of the transformed tiling state or calculated tiling state latency.

18. The apparatus of claim 17, wherein the means for initializing is to produce an initial action strategy using the initial tiling state, the initial action strategy including at least one of a factorization permutation of one of the subgroups and a calculation order in which the matrices are multiplied.

19. The apparatus of claim 17, including means for training a machine learning model using at least the initial tiling state of one or more subgroups of the detected matrices.

20. The apparatus of claim 19, wherein the means for training is to retrain the machine learning model using the transformed tiling state and the calculated tiling state latency.

21-25. (canceled)
